(19) United States
(12) Patent Application Publication
(10) Pub. No.: US 2016/0148154 A1
(43) Pub. Date: May 26, 2016

(54) SYSTEMS AND METHODS FOR PARCEL DELIVERY TO ALTERNATE DELIVERY LOCATIONS

(71) Applicant: United Parcel Service of America, Inc., Atlanta, GA (US)

(72) Inventors: Andy Tibbs, Roswell, GA (US); John Slayton, Brookhaven, GA (US)

(21) Appl. No.: 14/942,731

(22) Filed: Nov. 16, 2015

Related U.S. Application Data
(63) Continuation-in-part of application No. 14/170,298, filed on Jan. 31, 2014.
(60) Provisional application No. 62/080,135, filed on Nov. 14, 2014.
(60) Provisional application No. 61/759,800, filed on Feb. 1, 2013.

(51) Int. Cl. G06Q 10/08

(52) U.S. Cl. CPC G06Q 10/08355; G06Q 10/0836

(57) ABSTRACT

A system in various embodiments, is configured to redirect undeliverable parcels to alternate delivery locations. The parcels may be undeliverable due to an unavailability of an intended recipient of the parcels to sign for the parcels or otherwise take delivery of the parcels at the delivery address. The system may be configured to determine an eligibility of the undeliverable parcel to be redirected to an alternate delivery location and then determine a suitable alternate delivery location based at least in part on: one or more parcel recipient preferences, one or more parcel shipper preferences, a location of the delivery address, etc. The system may be further configured to notify the parcel recipient of a redirection of the parcel to the alternate delivery address.

### CROSS REFERENCE TO RELATED APPLICATION

This application is a continuation-in-part of U.S. patent application Ser. No. 14/170,298, filed 31 Jan., 2014, entitled, “Systems and Methods for Parcel Delivery to Alternate Delivery Locations,” which claimed the benefit of priority to U.S. Provisional Patent Application No. 61/759,800, filed Feb. 1, 2013, entitled, “Systems and Methods for Parcel Delivery to Alternate Delivery Locations,” both of which are incorporated herein by reference in their entirety; this application further claims the benefit of priority from U.S. Provisional Patent Application No 62/080,135, filed Nov. 14, 2014, entitled “Systems and Methods for Parcel Delivery to Alternate Delivery Locations”, which is hereby incorporated by reference in its entirety.

### SUMMARY

A computer system, according to particular embodiments, comprises at least one processor. In various embodiments, the computer system is configured for: (A) receiving, from a delivery driver, an indication that delivery of one or more parcels is not possible at a primary delivery location; (B) at least partially in response to receiving the indication, determining an eligibility of the one or more parcels to be redirected to an alternate delivery location; (C) at least partially in response to determining that the one or more parcels are eligible for redirection, retrieving alternate delivery location information associated with the primary delivery location; (D) determining, based at least in part on the alternate delivery location information, a suitable alternate delivery location; and (E) facilitating delivery of the one or more parcels from the primary delivery location to the suitable alternate delivery location. In particular embodiments, the alternate delivery location information comprises information selected from a group consisting of (i) one or more parcel recipient alternate delivery preferences; and (ii) one or more parcel shipper alternate delivery preferences.

A computer implemented method of directing parcels to alternate delivery locations, according to particular embodiments, comprises: (A) receiving, by a processor, an indication that delivery of a parcel is not possible at a primary delivery location; (B) retrieving, by a processor, alternate delivery location information associated with the primary delivery location; (C) determining, by a processor, based at least in part on the alternate delivery location information, an appropriate alternate delivery location; and (D) redirecting, by a processor, the parcel to the appropriate alternate delivery location.

A non-transitory computer-readable medium storing computer executable instructions, according to various embodiments, for: (A) receiving, from a delivery driver, an indication that delivery of a parcel to a primary delivery location is not possible; (B) at least partially in response to receiving the indication, determining a suitable alternate delivery location for the parcel; (C) at least partially in response to determining the suitable alternate delivery location, facilitating delivery of the parcel to the suitable alternate delivery location; and (D) notifying an intended recipient of the parcel of the delivery of the parcel to the suitable alternate delivery location.

### BRIEF DESCRIPTION OF THE DRAWINGS

Various embodiments of a system and method for delivering packages to alternate delivery locations are described below. In the course of this description, reference will be made to the accompanying drawings, which are not necessarily drawn to scale, and wherein:

FIG. 1 is a block diagram of an alternate delivery location delivery system in accordance with an embodiment of the present system;

FIG. 2 is a schematic diagram of a computer, such as the logistics server of FIG. 1, that is suitable for use in various embodiments;

FIG. 3 depicts a flow chart that generally illustrates various steps executed by a parcel redirection module that, for example, may be executed by the logistics server of FIG. 1;

FIG. 4 depicts a flow chart that generally illustrates various steps executed by a parcel redirection eligibility determination module that, for example, may be executed by the logistics server of FIG. 1; and

FIGS. 5-6 are transportation diagrams depicting exemplary transportation paths taken by packages that are delivered to alternate delivery locations.

### DETAILED DESCRIPTION OF VARIOUS EMBODIMENTS

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

In particular embodiments, a system for delivering packages is configured to facilitate the delivery of parcels to alternate delivery locations (e.g., via a common carrier, logistics company, etc.). In particular embodiments, an alternate delivery location may include a location other than the address of the parcel's intended recipient. In various embodiments, these alternate delivery locations include retail stores (e.g., including gas stations, grocery stores, and pharmacies), stand-alone kiosks, or any other suitable location for receiving and holding parcels for pick up by recipients. For example, a parcel originally scheduled for delivery to a primary delivery location (e.g., such as the recipient's residence) may be redirected to an alternate delivery location. In particular embodiments, the redirection of the parcel to an alternate delivery location occurs at least partially in response to a determination that delivery of the parcel to the primary delivery location is not possible (e.g., because the recipient is not home when an attempt is made to deliver the parcel, the parcel requires a signature, the person delivering the parcel determines that it would be unsafe to leave the parcel outside of the primary delivery location, or for any other suitable reason). In other embodiments, the redirection of the parcel to an alternate delivery location occurs at least partially in response to a request from the parcel recipient to redirect the parcel. As a particular example, when the recipient is notified via a service such as the My Choice service offered by UPS of Atlanta, Ga. that the recipient has a parcel scheduled for delivery, the recipient may elect to have the parcel delivered to an alternate delivery location instead of the scheduled delivery address.

In other embodiments, the system is configured to facilitate the delivery of parcels directly to alternate delivery locations from a business or other entity from which the shipment of the parcel originated. Direct deliveries to alternate delivery locations may include business-to-retail deliveries in which items ordered by a customer from a business (e.g., such as an e-commerce web site) are shipped directly to a retail location or other suitable alternate delivery location. For such deliveries, the items may be held at the alternate delivery location until picked up by the customer (e.g., the intended recipient). In such embodiments, the system may be configured to present customers with a selection of alternate delivery locations for items that the customer orders.

In various embodiments, the system is configured to confirm whether an alternate delivery location has capacity to accept a parcel before directing (e.g., or redirecting) a parcel to the alternate delivery location. This may include, for example, ensuring that there is enough physical space at the alternate delivery location to accept the parcel or suitable systems in place at the alternate delivery location to accommodate any special handling instructions that the parcel may have (e.g., a requirement to store the parcel at a particular temperature). In such embodiments, the system may be further configured to substantially automatically (e.g., automatically) reserve space at the alternate delivery location for the parcel to ensure that the alternate delivery location will not lose capacity to accept the parcel before the parcel arrives.

In particular embodiments, the system is configured to determine whether a particular parcel is eligible for redirection to an alternate delivery location before redirecting the parcel. For example, a particular parcel may be determined to be ineligible for redirection due to, at least in part, a size of the particular parcel, a weight of the particular parcel, one or more contents of the particular parcel, one or more special handling requirements of the particular parcel, etc.

In particular embodiments, shipping items directly to alternate delivery locations provides a cost savings to common carriers and other shipping and/or logistics companies by avoiding the need to deliver parcels and other items to the home addresses of individual parcel recipients. Rather, the common carriers can deliver parcels to several alternate delivery locations that service a particular area where parcel recipients can go to collect their parcels.

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus to create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

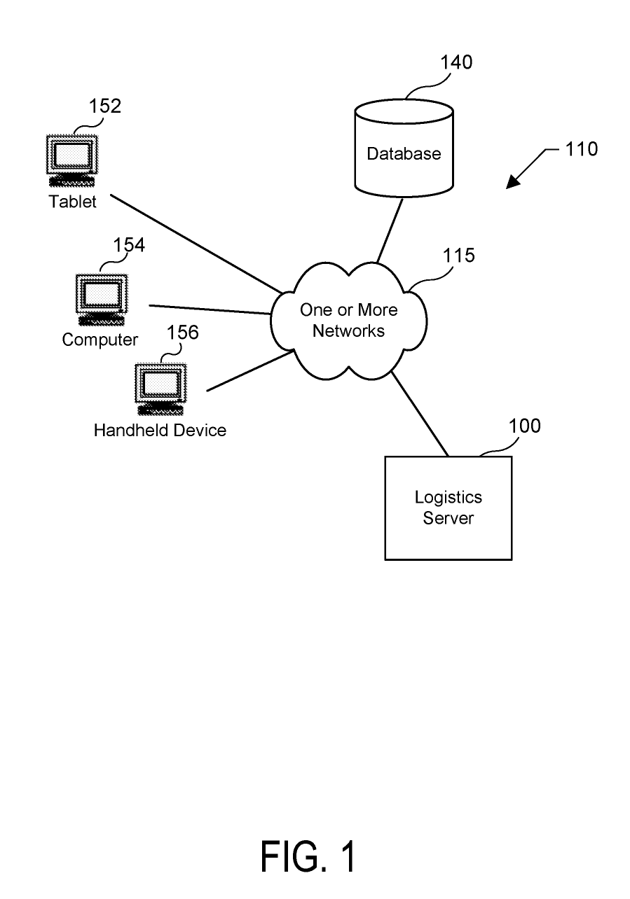

FIG. 1 is a block diagram of a System 110 according to a particular embodiment. As may be understood from this figure, the System 110 includes one or more computer networks 115, a Logistics Server 100, a Database 140, and one or more remote computing devices such as a tablet computer 152, a desktop or laptop computer 154, or a handheld computing device 156, such as a cellular phone. In particular embodiments, the one or more computer networks 115 facilitate communication between the Logistics Server 100, Database 140, and one or more remote computing devices 152, 154, 156.

One or more computer networks 115 may include any of a variety of types of wired or wireless computer networks such as the Internet, a private intranet, a public switch telephone network (PSTN), or any other type of network. The communication link between Logistics Server 100 and Database 140 may be, for example, implemented via a Local Area Network (LAN) or via the Internet.

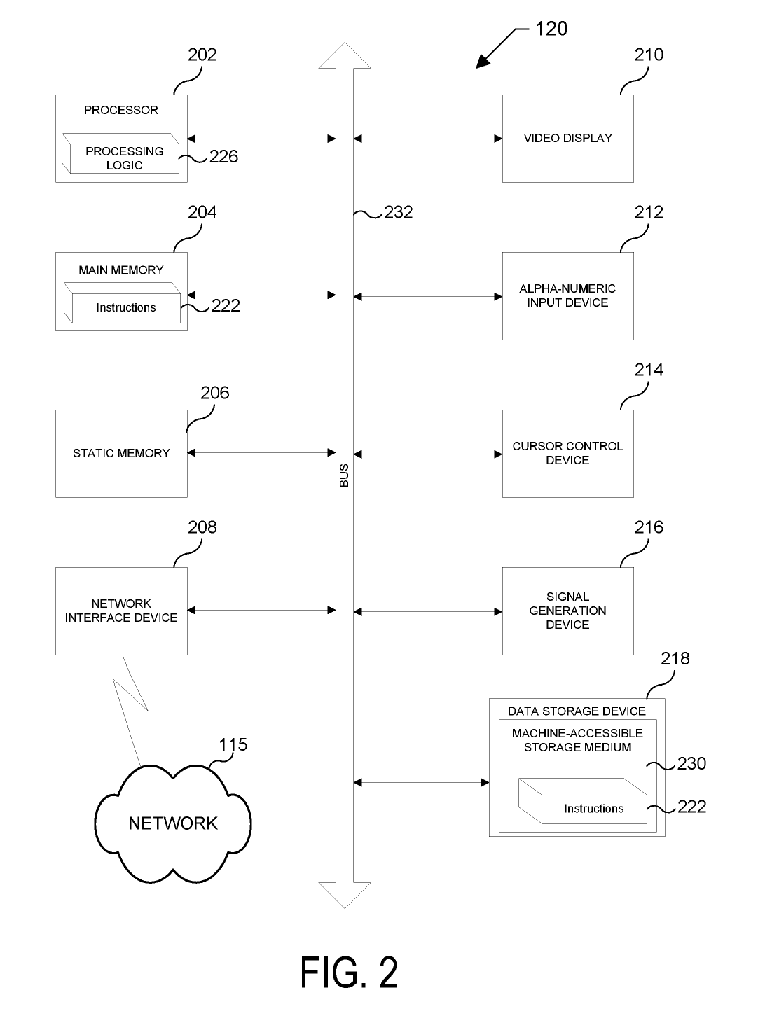

FIG. 2 illustrates a diagrammatic representation of a computer architecture 120 that can be used within the System 110, for example, as a client computer (e.g., one of client computers 152, 154, 156 shown in FIG. 1), or as a server computer (e.g., Logistics Server 100 shown in FIG. 1). In particular embodiments, the computer 120 may be suitable for use as a computer within the context of the System 110 that is configured to facilitate the delivery of parcels to alternate delivery locations or facilitate the receipt and/or processing of parcels once they are delivered to the alternate delivery locations.

In particular embodiments, the computer 120 may be connected (e.g., networked) to other computers in a LAN, an intranet, an extranet, and/or the Internet. As noted above, the computer 120 may operate in the capacity of a server or a client computer in a client-server network environment, or as a peer computer in a peer-to-peer (or distributed) network environment. The Computer 120 may be a personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computer 120 includes a processing device 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

The processing device 202 represents one or more general-purpose processing devices such as a microprocessor, a central processing unit, or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computer 120 may further include a network interface device 208. The computer 120 also may include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

The data storage device 218 may include a non-transitory computer-accessible storage medium 230 (also known as a non-transitory computer-readable storage medium or a non-transitory computer-readable medium) on which is stored one or more sets of instructions (e.g., software 222) embodying any one or more of the methodologies or functions described herein. The software 222 may also reside, completely or at least partially, within main memory 204 and/or within processing device 202 during execution thereof by computer 120—main memory 204 and processing device 202 also constituting computer-accessible storage media. The software 222 may further be transmitted or received over a network 220 via network interface device 208.

While the computer-accessible storage medium 230 is shown in an exemplary embodiment to be a single medium, the term “computer-accessible storage medium” should be understood to include a single medium or multiple media (e.g., a centralized or distributed database, and/or associated caches and servers) that store the one or more sets of instructions. The term “computer-accessible storage medium” should also be understood to include any medium that is capable of storing, encoding or carrying a set of instructions for execution by the computer and that cause the computer to perform any one or more of the methodologies of the present invention. The term “computer-accessible storage medium” should accordingly be understood to include, but not be limited to, solid-state memories, optical and magnetic media, etc.

### Exemplary System Platform

Various embodiments of a system for delivering parcels to alternate delivery locations may be implemented within the context of any suitable service. For example, particular embodiments may be implemented within the context of any service offered by United Parcel Service of Atlanta, Ga. Various aspects of the system's functionality may be executed by certain system modules, including a Parcel Redirection Module 300 and a Parcel Redirection Eligibility Determination Module 400. These modules are discussed in greater detail below.

### Parcel Redirection Module

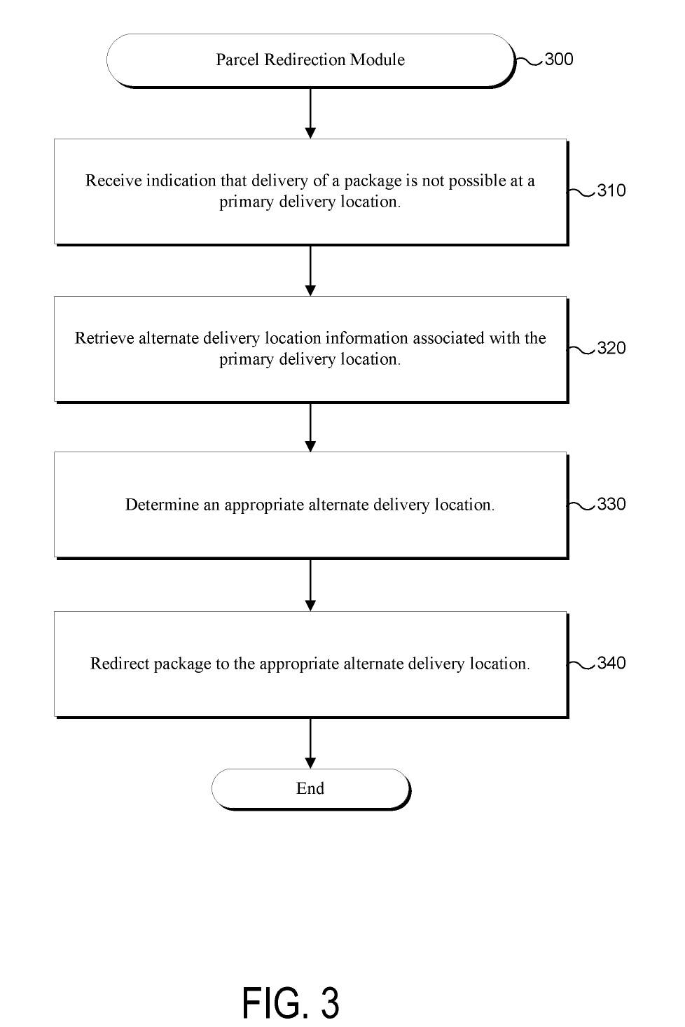

FIG. 3 is a flow chart of operations performed by an exemplary Parcel Redirection Module 300. In particular embodiments, the Parcel Redirection Module 300 may facilitate the redirection of parcels from a primary delivery location (e.g., such as the parcel recipient's residence or other address to which the parcel is addressed) to an alternate delivery location.

When executing the Parcel Redirection Module 300, the system begins, at Step 310, by receiving an indication that delivery of one or more parcels is not possible at a primary delivery location. In various embodiments, the system receives the indication that the one or more parcels are undeliverable from a delivery driver who was unable to perform the delivery. In particular embodiments, the system is configured to receive the indication in any suitable manner (e.g., via input on a wireless device such as a smart phone or DIAD). A delivery of a parcel may not be possible, for example, because the parcel recipient is not home to receive the parcel, because no one is present at the primary delivery location to sign for the parcel if the parcel requires signature confirmation, or for any other suitable reason.

The system continues, at Step 320, by retrieving alternate delivery location information for the one or more parcels. In various embodiments, alternate delivery location information includes the following: (1) alternate delivery location availability information; (2) parcel recipient alternate delivery location preferences; and (3) parcel shipper alternate delivery location preferences. Each of these is described below.

### Alternate Delivery Location Availability Information

In particular embodiments, the alternate delivery location information retrieved by the system includes the locations of one or more alternate delivery locations as well as information relating to the ability of those one or more alternate delivery locations to receive parcels. In various embodiments, the system is configured to retrieve location information for one or more alternate delivery locations that are within a particular distance of the primary delivery location to which delivery of the one or more parcels was not possible. In particular embodiments, the particular distance from the primary delivery location for which the system retrieves alternate delivery location information depends at least in part on the primary delivery location (e.g., whether the primary deliver location is in an urban or rural setting, is a business or residential address, etc.).

As a particular example, when a primary delivery location is in an urban or more densely populated area, the system may be configured to retrieve information for one or more alternate delivery locations that are no more than a short distance from the primary delivery location (e.g., within walking distance of the primary delivery location, within 1 mile of the primary delivery location, within a particular number of stops on a public transportation system from the primary delivery location, etc.). In a different example, when a primary delivery location is in a rural area, the system may be configured to retrieve information for one or more alternate delivery locations that are farther from the primary delivery location (e.g., up to ten miles from the primary delivery location, within a fifteen minute drive of the primary delivery location, etc.). In various embodiments, the system may be configured to retrieve information associated with one or more alternate delivery locations that are within a particular travel time of the primary delivery location (e.g., via car, on foot, via public transportation, etc.).

In various embodiments, the system is configured to determine alternate delivery location information based at least in part on a location of a delivery driver, which may, for example, be determined based on a location of a mobile device (e.g., such as a smart phone or DIAD) associated with the delivery driver (e.g., based on GPS coordinates of the mobile device, etc.). In such embodiments, the system may be configured to locate one or more alternate delivery locations that are no more than a particular distance from the delivery driver as discussed above. In other embodiments, the system may be configured to locate one or more alternate delivery locations that are no more than a particular distance from a delivery route of the delivery driver (e.g., one or more alternate delivery locations to which the delivery driver could deliver the one or more parcels without substantially deviating from their delivery route).

In particular embodiments, the one or more alternate delivery locations may include, for example, one or more retail stores (e.g., including gas stations, grocery stores, and pharmacies), stand-alone kiosks, or any other suitable location for receiving and holding parcels for pick up by recipients. In various embodiments, the one or more alternate delivery locations may have limited capacity for receiving and holding parcels (e.g., redirected parcels) until the parcels are picked up by the intended recipients. For example, an alternate delivery location that is part of a grocery store may have limited physical storage space (e.g., shelf space) for storing parcels. Other alternate delivery locations may be unable to store particular parcels that require special handling (e.g., refrigeration or other temperature storing requirements). In various embodiments, the alternate delivery location information includes information relating to the ability of a particular alternate delivery location to receive and store a parcel. In particular embodiments, the system may substantially continuously (e.g., continuously) update capacity information for a particular alternate delivery location. In other embodiments, the system may update capacity information for a particular alternate delivery location other than substantially continuously (e.g., once per day, twice per day, hourly, etc.).

### Parcel Recipient Alternate Delivery Location Preferences

In particular embodiments, the system is configured to retrieve alternate delivery location information that includes one or more parcel recipient preferences related to one or more alternate delivery locations. These one or more parcel recipient preferences may be provided to the system by parcel recipients, for example, and may include preferences related to particular alternate delivery locations to which recipients would like their parcels redirected following unsuccessful deliveries. In particular embodiments, the system is configured to allow parcel recipients to provide a list of preferred alternate delivery locations that are ranked from most preferred to least preferred. In various embodiments, the system is configured to redirect parcels to the parcel recipient's most preferred alternate delivery location that is able to accept the parcel. A parcel recipient may, for example, provide a most preferred alternate delivery location that is situated between the recipient's home and place of work, so that the recipient can pick up the parcel from the alternate delivery location on the way home from work. In various embodiments, a parcel recipient's most preferred alternate delivery location may be unavailable to accept delivery of a particular parcel. In such cases, the system may be configured to redirect the parcel to the parcel recipient's second most preferred alternate delivery location (and so on).

In various embodiments, the system is configured to allow a parcel recipient to provide preferred alternate delivery locations for any parcel that the recipient may receive (e.g., for all parcels scheduled for shipment to the parcel recipient, regardless of the source of the parcel). In other embodiments, the system is configured to allow a parcel recipient to select or provide one or more preferred alternate delivery locations for specific parcels (e.g., in response to the parcel recipient receiving a notification that the parcel recipient is currently scheduled to receive a particular parcel). In particular embodiments, following an unsuccessful delivery attempt, the system may be configured to notify the parcel recipient that the carrier was unable to deliver the parcel to the primary delivery location and is further configured to provide the parcel recipient with a selection of alternate delivery locations to which the parcel can be directed. In various embodiments, the system is configured to only provide selected alternate delivery locations from which the parcel recipient may choose that have substantially current (e.g., current) availability to accept the parcel.

In various embodiments, following an unsuccessful delivery attempt, the system may be configured to provide the parcel recipient with a selection of available alternate delivery locations and a time period during which the parcel recipient may select an alternate delivery location from the selection of alternate delivery locations. In response to receiving the selection from the parcel recipient, the system may be configured to redirect the parcel to the selected alternate delivery location. If the system does not receive a selection from the parcel recipient during the time period, the system may be configured to substantially automatically (e.g., automatically) determine a suitable alternate delivery location and redirect the parcel to that location.

### Parcel Shipper Alternate Delivery Location Preferences

In various embodiments, the system is configured to allow a shipper to select whether parcels that the shipper sends to recipients can be redirected to alternate delivery locations following unsuccessful delivery attempts. For example, when sending a parcel, the shipper may indicate that the parcel should not be rerouted to an alternate delivery location in the event of an unsuccessful delivery attempt. In particular embodiments, shippers may opt out of allowing parcels that the shipper sends to be rerouted to alternate delivery locations for any suitable reason (e.g., because of the nature of the item being shipped, etc.).

The system continues, at Step 330, by determining an appropriate alternate delivery location based at least in part on the alternate delivery location information retrieved at Step 320. The system may, for example, determine that the appropriate alternate delivery location is the alternate delivery location that is highest on the parcel recipient's list of preferred alternate delivery locations that has sufficient capacity to receive the parcel in terms of space and special handling requirements. As another example, the system may determine that no alternate delivery location is suitable to receive a parcel (e.g., because the shipper indicated a preference for the parcel not to be redirected to an alternate delivery location). In this example, the parcel may be returned to a local distribution center instead of an alternate delivery location and delivery may be attempted on the following day or at any other suitable time.

In particular embodiments, the system is configured to determine an appropriate alternate delivery location based at least in part on a size and/or weight of the parcel. For example, parcels of a particular size may be too large to leave at the primary delivery location when no one is available to accept the delivery of the parcel (e.g., because the size of the parcel may render the parcel more susceptible to theft if left outside of the primary delivery location). As a different example, parcels that are particularly large in size and/or weight may be unsuitable for redirection to an alternate delivery location due to the difficulty that a parcel recipient may face in transporting a parcel picked up at an alternate delivery location to the parcel recipient's residence. For example, parcels of a certain size or weight may be difficult for a parcel recipient to fit in the parcel recipient's vehicle or may be too heavy for the parcel recipient to carry. For such parcels, the system may be configured to direct a common carrier delivery driver to release the parcel at the primary delivery address (e.g., by leaving the parcel at the primary delivery address) rather than redirecting the parcel to an alternate delivery location. The system may, for example, have a size or weight limit that parcels must be lighter and/or smaller than in order to be eligible for redirection.

Returning to FIG. 3, the system continues, at Step 340, by directing the parcel to the appropriate alternate delivery location determined at Step 330. In particular embodiments, directing the parcel to the appropriate delivery location comprises substantially automatically (e.g., automatically) reserving space at that alternate delivery location for the parcel (e.g., to ensure that there will be room and/or capacity for the parcel once the parcel arrives at the alternate delivery location). In various embodiments, directing the parcel to the appropriate alternate delivery location further comprises confirming that the parcel has been deposited at a particular alternate delivery location. In various embodiments, confirming that the parcel has been deposited at the alternate delivery location may include receiving a scan of an indicia associated with and located at the alternate delivery location from a delivery driver when the delivery driver deposits the parcel at the alternate delivery location. For example, when depositing a parcel at an alternate delivery location, the driver may scan the parcel and then scan an indicia (e.g., such as a bar code, QR code, or other suitable indicia) that is physically located at the alternate delivery location (e.g., on a wall, counter, etc.). At least partially in response to receiving a scan of a parcel followed by a scan of an indicia of a particular alternate delivery location, the system, in various embodiments, is configured to associate the parcel with that alternate delivery location (e.g., for the purposes of tracking the parcel, notifying the intended parcel recipient of the location of the parcel, etc.). In other embodiments, the system is configured to confirm delivery of a parcel at an alternate delivery location using any other suitable technique (e.g., GPS tracking, geocoding, etc.). In particular embodiments, the system is configured to notify the parcel recipient that the parcel has been delivered to the alternate delivery location (e.g., via e-mail, SMS, text message, or any other suitable method of communication).

### Parcel Redirection Eligibility Determination Module

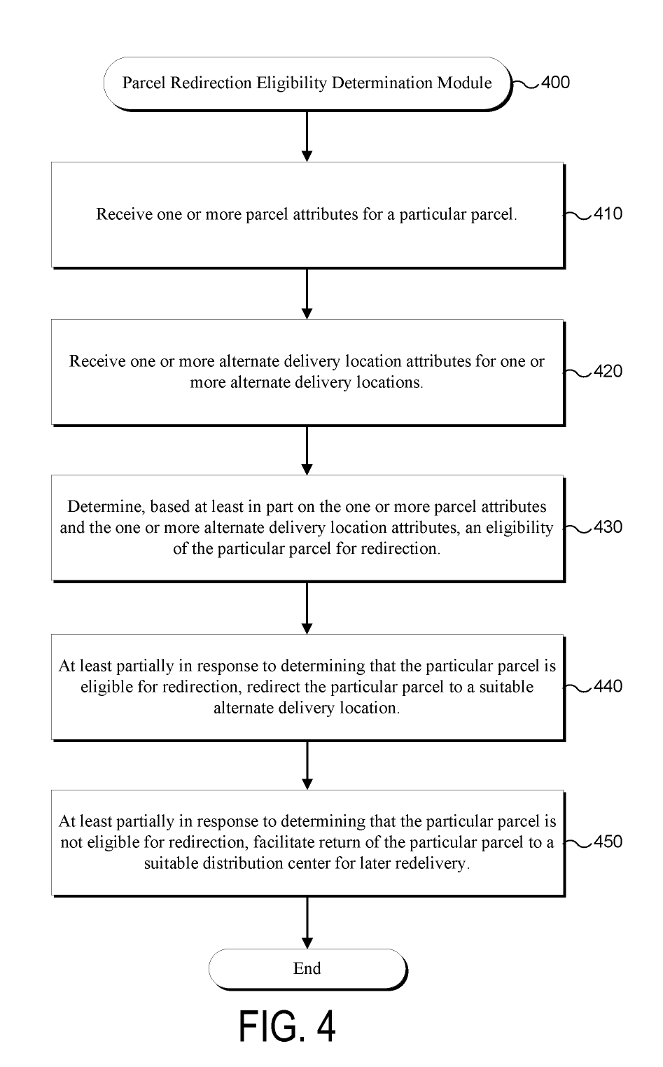

FIG. 4 is a flow chart of operations performed by an exemplary Parcel Redirection

Eligibility Determination Module 400. In particular embodiments, the Parcel Redirection Eligibility Determination Module 400 may determine an eligibility of a particular parcel for redirection to a particular alternate delivery location, based, for example, on one or more attributes of the particular parcel and/or of the particular alternate delivery location.

When executing the Parcel Redirection Eligibility Determination Module 400, the system, in various embodiments, begins at Step 410 by receiving one or more parcel attributes associated with a particular parcel. In particular embodiments, the particular parcel is a parcel for which the system determined that delivery at a primary delivery location was not possible, for example, at Step 310 of the Parcel Redirection Module discussed above.

In various embodiments, the one or more parcel attributes may comprise, for example; (1) one or more dimensions of the particular parcel (e.g., height, width, length, etc.); (2) one or more shapes of the particular parcel (e.g., oblong, rectangular, cylindrical, or any other suitable shape); (3) a weight of the particular parcel; (4) a requirement that the parcel recipient pay cash on delivery (COD) for the particular parcel; and/or (5) one or more special handling instructions associated with the particular parcel.

In particular embodiments, the one or more special handling instructions may include, for example, one or more special handling instructions related to a perishable nature of one or more contents of the particular parcel. In various embodiments, perishable contents may include any contents that may deteriorate over a given period of time if exposed to harsh environmental conditions such as, for example, excessive temperature (e.g., extreme heat or cold) or humidity. For example, the particular parcel may contain one or more perishable food items (e.g., seafood, dairy, meat, fruits, vegetables, etc.), or other perishable items (e.g., flowers, plants, live tropical fish, etc.). In various embodiments, the one or more special handling instructions may include an instruction related to a need to refrigerate one or more contents of the particular parcel. The particular parcel may contain, for example, meat or other items that require refrigeration.

In certain embodiments, in determining whether a particular parcel containing one or more perishable items is eligible for redirection to a particular alternate delivery location, the system determines whether the alternate delivery location includes refrigerated storage. The system may be configured to determine that the particular parcel is not eligible for redirection to the particular alternate delivery location in response to determining, for example: (1) that the alternate delivery location doesn't include refrigerated storage; or (2) that the alternate delivery location doesn't include sufficient refrigerated storage to store the parcel at a particular time or for a particular period of time.

In various embodiments, the one or more special handling instructions may relate to one or more hazardous materials contained within the particular parcel. For example, a particular parcel may include one or more dangerous goods such as, for example, magnetized material, toxics in exemption packaging, environmentally hazardous substances, explosives, ammunition, weapons, radioactive materials, or other hazardous or dangerous items. Other hazardous items may include, for example: air bags (e.g., which may contain air bag inflators); air conditioning equipment (e.g., which may contain gases under pressure); aircraft parts (e.g., which may contain such items as fuel control devices which cannot be fully purged of fuel); auto parts (e.g., which may include carburetors, gas lines, or gas tanks which may contain gasoline); barometers (e.g., which may indicate the presence of mercury); batteries; breathing apparatuses (e.g., which may include oxygen cylinders under pressure); bull semen (e.g., which may be shipped with dry ice or other liquefied gas); camping gear/equipment (e.g., which may include ammunition, batteries, cooking stoves, flammable gas, fire starting pastes, flammable liquids, heat producing packets, lighters, matches, signal flares, STERNO cooking/heating fuel; chain saws and other powered tools (e.g., which may contain fuel residue); cigarette lighters (e.g., which may contain flammable gas or liquid); computer equipment (e.g., which may contain uninterruptible power supplies with electrical storage batteries, magnets in speakers and printing ink); construction equipment (e.g., which may include the presence of batteries, CO2 cartridges, and other power devices, gasoline powered saws, generators, and/or space heaters all possibly containing fuel, liquefied petroleum gas torches, paints, drying agents, and thinners); cosmetics (e.g., which may contain flammable liquids); cryogenic liquids (e.g., or other liquefied gas stored at very low temperatures); cylinders, containers, and/or tanks (e.g., which may contain flammable or non-flammable compressed gases); dental apparatus/equipment (e.g., which may contain hazardous chemicals such as resins, solvents, or gases); drilling and mining equipment (e.g., which may contain explosives, acids, lubricants, mercury or other dangerous goods); electrical/electronic equipment (e.g,. which may contain powerful magnets, mercury in switches, any one of a variety of batteries and uninterruptible power supplies containing electrical storage batteries; electrically powered apparatus (e.g., which may contain wet electric storage batteries, or lithium batteries); engine parts (e.g., which may include carburetors, gas lines, or gas tanks which may contain fuel or fuel residue); fertilizer (e.g., which may include ammonium nitrate); fire extinguishers (e.g., which may contain gases under pressure); frozen food (e.g., which may contain dry ice); household goods (e.g., which may include paints, bleaches, spray cans under pressure, etc.); machine parts (e.g., which may include adhesives, paints, sealants, solvents or other chemicals and gases); medical supplies (e.g., which may contain flammable or corrosive chemicals, infectious substances or radioactive materials); or any other hazardous material.

In various embodiments, the one or more special handling instructions may relate to one or more age-restricted items contained within the particular parcel (e.g., alcohol such as wine, which may require signature by a person of a particular age), or any other item which may require special handling.

The system continues, at Step 420, by receiving one or more alternate delivery location attributes associated with one or more alternate delivery locations. In various embodiments, the one or more alternate delivery locations include the appropriate alternate delivery location determined at Step 330 above. In other embodiments, the one or more alternate delivery locations include any potential alternate delivery location to which the particular parcel may be redirected (e.g., determined from the alternate delivery location availability information, recipient alternate delivery location preferences, and/or shipper alternate delivery location preferences described above).

In various embodiments, the one or more alternate delivery location attributes may include, for example; (1) an amount of space available at the one or more alternate delivery locations; (2) one or more parcel content restrictions in place at the one or more alternate delivery locations; and/or (3) one or more special handling capabilities of the one or more alternate delivery locations. In various embodiments, an alternate delivery location may not be equipped to accept delivery of a parcel of a particular size (e.g., a parcel that is too large or that has unusual dimensions). For example, an alternate delivery location located at a gas station may be unable to accept delivery of larger items due to having insufficient space to store the item until it is retrieved by the parcel recipient.

In particular embodiments, a particular alternate delivery location may restrict what sorts of hazardous materials may be accepted at the particular location. For example a grocery store may not accept delivery of parcels containing dangerous chemicals or other dangerous items which could potentially cause one or more issues with food in the grocery store if the parcel contents were to leach out, spill, etc.

In particular embodiments, a particular alternate delivery location may have certain special handling capabilities such as, for example, temperature and/or humidity controlled environment or storage (e.g., a refrigerator); one or more employees with an appropriate special handling skill (e.g., a license to handle a particular type of hazardous material); a means to confirm a parcel recipient's age (e.g., an employee to check ID for age-restricted items).

Continuing at Step 430, the system determines an eligibility of the particular parcel for redirection based at least in part on the one or more parcel attributes and one or more alternate delivery location attributes. In particular embodiments, the system is configured to determine the eligibility of the particular parcel for redirection before determining an appropriate alternate delivery location as described above. In other embodiments, the system is configured to determine whether the particular parcel is eligible for redirection before redirecting the parcel to the determined appropriate alternate delivery location. In various embodiments, the system is configured, at least partially in response to determining that the particular parcel is eligible for redirection, to continue to Step 440 and redirect the parcel to the appropriate alternate delivery location. In other embodiments, the system is configured, at Step 450, at least partially in response to determining that the particular parcel is not eligible for redirection, to return the parcel to a suitable distribution center to reattempt delivery at a later time.

### Alternate Embodiments

### Direct to Alternate Delivery Location Shipments

In various embodiments, businesses provide customers with the option of having items scheduled for shipment to those customers (e.g., purchased by those customers) shipped directly to alternate delivery locations, rather than having the items shipped to the customer's home or office. In such embodiments, the businesses may provide a selection of alternate delivery locations to which the customer may send shipments. In other embodiments, the alternate delivery locations may be supplied by the common carrier that coordinates the shipment of the item. For example, a common carrier such as UPS may have particular alternate delivery locations associated with the common carrier in a particular city (e.g., such as Atlanta, Ga.). A customer ordering an item for shipment to that particular city may, when ordering the item, be presented with a listing of the particular alternate delivery locations associated with the common carrier. In particular embodiments, the system is configured to substantially automatically (e.g., automatically) reserve space at an alternate delivery location for an item ordered by a customer at least partially in response to the customer selecting that alternate delivery location as the shipping destination of the item the customer is to receive.

### Packaging for Business-to-Retail Parcels

In particular embodiments, an alternate delivery location that accepts parcels shipped directly to the alternate delivery location may also receive parcels intended for the alternate delivery location itself. For example, a grocery store that acts as an alternate delivery location may receive parcels that are shipped to and intended for the grocery store in addition to parcels that are shipped to the grocery store but intended for storage at the alternate delivery location associated with the grocery store until the parcel can be picked up by a parcel recipient. In such instances, parcels that are directed to an alternate delivery location and intended for a person other than the alternate delivery location itself may contain an indicia indicating that the parcel is to be picked up by the parcel recipient rather than opened by someone at the alternate delivery location. In such embodiments, the indicia can allow alternate delivery locations to differentiate between parcels intended for the alternate delivery location and parcels that have been shipped to or redirected to the alternate delivery location but are to be picked up by a different parcel recipient.

In various embodiments, the indicia may include a particular marking on parcels intended for pick up by parcel recipients (e.g., a particular color marking, sticker, label, etc.). In particular embodiments, the indicia are machine-readable indicia that are readable to update tracking information associated with the parcel (e.g., updating information to notify the parcel recipient that the parcel is “ready for pick up”).

### Non-Guaranteed Deliveries

In particular embodiments, the system is configured to provide customers with a non-guaranteed shipping option (e.g., a shipping option that does not guarantee shipment within a particular number of days). The system may be configured to make periodic shipments from any particular business to a particular alternate delivery location. For example, a common carrier may provide a non-guaranteed shipping option for items shipped from a particular online electronics retailer to a particular alternate delivery location, and the common carrier may then only make shipments from the particular online electronics retailer to the particular alternate delivery location once per week (e.g., or once every other week, etc.). In various embodiments, a common carrier may charge less for a non-guaranteed shipping option than for other shipping options (e.g., such as two day shipping, overnight, etc.).

In other embodiments, the system is configured to release shipments placed with non-guaranteed shipping options from a particular retailer to a particular alternate delivery location only when a particular number of orders have been placed from that particular retailer for shipment to that particular alternate delivery location. For example, the system may be configured to only send a shipment of items or parcels from that particular retailer to that particular alternate delivery location once a sufficient number of orders have been placed with non-guaranteed shipping from that particular retailer to that particular alternate delivery location to substantially fill (e.g., completely fill) an entire delivery truck.

In still other embodiments, the system may be configured to hold any parcels scheduled for delivery to a particular parcel recipient until a predetermined number of parcels have been scheduled for shipment to the particular parcel recipient. For example, a logistic company's regional distribution center may contain a bin that can hold 10 parcels for the particular parcel recipient in which all parcels for that particular recipient are placed. The parcels would then be delivered once the bin had filled up with 10 parcels in order to decrease the number of trips needed to deliver all of the parcels to the particular parcel recipient (e.g., to the recipients residence or an alternate delivery location selected by the recipient).

### Illustrative Examples

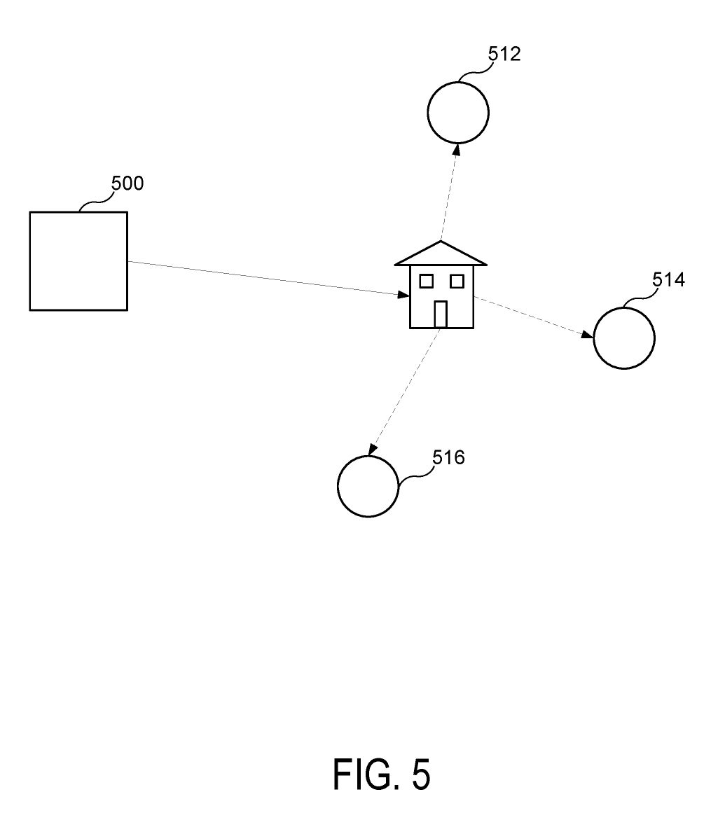

FIG. 5 shows an exemplary transportation diagram that generally illustrates the redirection of a delivery from a primary delivery location to an alternate delivery location. As shown in this figure, a parcel 500 may be delivered from any suitable starting point (e.g., such as a local distribution center, retailer, warehouse, etc.) to a primary delivery location 504 (e.g., such as a residence, office, etc.). If it is not possible to deliver the parcel 500 to the primary delivery location 504, the system will redirect the parcel to an alternate delivery location 512, 514, 516. The alternate delivery locations may include, for example, gas stations, grocery stores, pharmacies, stand-alone kiosks, or any other suitable location for receiving and holding parcels for pick up by recipients.

In various embodiments, a system for directing parcels to alternate delivery locations will determine the most suitable alternate delivery location to which the parcel should be delivered. In the example shown in FIG. 5, the parcel recipient may have provided the parcel carrier (e.g., the company responsible for delivering the parcel to the recipient) with an ordered list of preferred alternate delivery locations, such as a preference for alternate delivery locations A, B, and C, in that order. The system, when determining the most suitable alternate delivery location for the undeliverable parcel, may determine which alternate delivery location is most preferable to the parcel recipient that also has availability to receive and hold the parcel until the recipient can pick the parcel up from the alternate delivery location. If, for example, alternate delivery location A 512 is completely full and cannot accept any more parcels, but alternate delivery location B 514 has space to receive the parcel 500, the system would determine that alternate delivery location B 514 is the most suitable alternate delivery location. The system may then redirect the parcel to alternate delivery location B 514. In various embodiments, the system is configured to substantially automatically reserve space for the parcel 500 at the alternate delivery location determined to be most suitable (e.g., in this case, the system would reserve space for the parcel at alternate delivery location B 514). In such embodiments, reserving space may avoid a problem where an alternate delivery location was determined to have availability, but when the parcel finally reached the alternate delivery location, there was no longer availability.

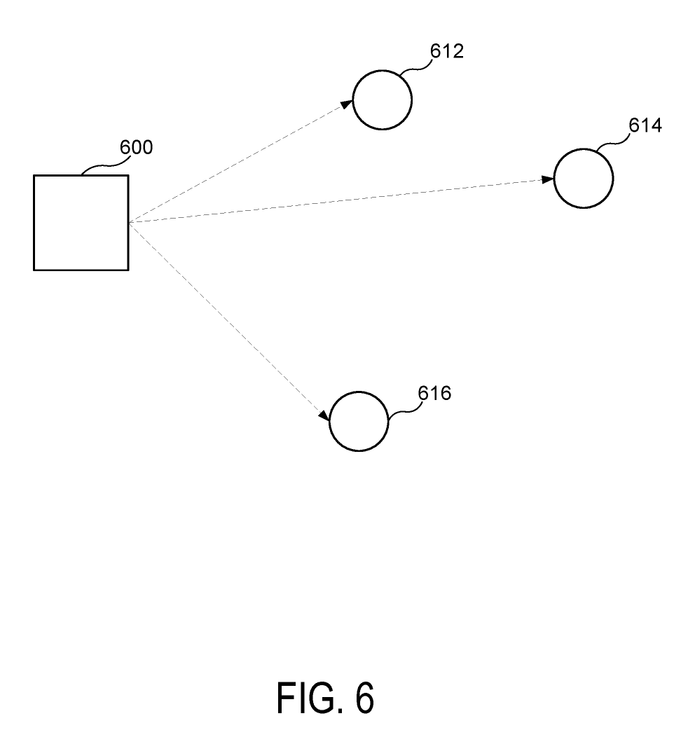

FIG. 6 depicts an exemplary transportation diagram that generally illustrates the delivery of a parcel 600 directly from a retailer to an alternate delivery location 612, 614, 616. As may be understood from this figure, parcel recipients may elect to have parcels delivered directly to alternate delivery locations 612, 614, 616. In various embodiments, logistics companies or common carriers may limit the frequency with which they make deliveries to a particular alternate delivery location or for a particular parcel recipient. In such embodiments, the logistics company or common carrier may make no guarantee as to how much time it will take to ship the parcel to its ultimate destination as discussed above.

### CONCLUSION

Many modifications and other embodiments of the invention will come to mind to one skilled in the art to which this invention pertains having the benefit of the teachings presented in the foregoing descriptions and the associated drawings. While examples discussed above cover the use of the invention in the context a parcel redirection service, the invention may be used in any other suitable context. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

We claim:

1. A computer-implemented method of determining whether to deliver a particular parcel to a particular alternate delivery location, comprising:
receiving, by a processor, an indication that delivery of the particular parcel is not possible at a primary delivery location;
receiving, by a processor, one or more parcel attributes associated with the particular parcel;
receiving, by a processor, one or more alternate delivery location attributes for one or more alternate delivery locations;
determining, by a processor, based at least in part on the one or more alternate delivery location attributes and the one or more parcel attributes, whether the particular parcel is eligible for redirection to an alternate delivery location;
at least partially in response to determining that the particular parcel is eligible for redirection, redirecting the particular parcel to a suitable alternate delivery location; and
at least partially in response to determining that the particular parcel is not eligible for redirection, facilitating a return of the particular parcel to a suitable distribution center for later redelivery to the primary delivery location.

2. The computer-implemented method of claim 1, wherein the one or more parcel attributes comprise one or more special handling instructions associated with the particular parcel.

3. The computer-implemented method of claim 2, wherein the one or more special handling instructions are selected from a group consisting of:
one or more special handling instructions related to a perishable nature of one or more contents of the particular parcel;
one or more special handling instructions related to a need to refrigerate one or more contents of the particular parcel;
one or more special handling instructions related to one or more hazardous materials contained within the particular parcel; and
one or more special handling instructions related to one or more age-restricted items contained within the particular parcel.

4. The computer-implemented method of claim 3, wherein the one or more alternate delivery location attributes comprise one or more special handling capabilities associated with the one or more alternate delivery locations.

5. The computer-implemented method of claim 4, wherein the one or more special handling capabilities comprise one or more climate control capabilities.

6. The computer-implemented method of claim 5, wherein the one or more climate control capabilities comprise refrigeration.

7. The computer-implemented method of claim 1, wherein:
the one or more alternate delivery locations comprise one or more alternate delivery locations within a particular distance of the primary delivery location;
the one or more alternate delivery location attributes comprise one or more special handling capabilities of the one or more alternate delivery locations; and
the one or more parcel attribute comprise one or more special handling instructions associated with the particular parcel.

8. The computer-implemented method of claim 1, further comprising determining by a processor, the suitable alternate delivery location based at least in part on one or more preferences received from an intended recipient of the particular parcel.

9. A non-transitory computer-readable medium storing computer executable instructions for:
receiving, from a delivery driver, an indication that delivery of a parcel to a primary delivery location is not possible;
receiving one or more parcel attributes associated with the parcel;
at least partially in response to receiving the indication, determining, based at least in part on the one or more parcel attributes, whether the parcel is eligible for redirection to an alternate delivery location;
at least partially in response to determining that the parcel is eligible for redirection:
determining a suitable alternate delivery location for the parcel;
facilitating redirection of the parcel to the suitable alternate delivery location; and
notifying an intended recipient of the parcel of the redirection of the parcel to the suitable alternate delivery location; and
at least partially in response to determining that the parcel is not eligible for redirection, facilitating a return of the particular parcel to a suitable distribution center for later redelivery to the primary delivery location.

10. The non-transitory computer-readable medium of claim 9, wherein determining the suitable alternate delivery location comprises:
receiving one or more locations of one or more potential alternate delivery locations;
receiving one or more alternate delivery location attributes for the one or more potential alternate delivery locations;
determining, based at least in part on the one or parcel attributes and the one or more alternate delivery location attributes, which of the one or more potential alternate delivery locations can accept delivery of the parcel; and
selecting the suitable alternate delivery location from the one or more potential alternate delivery locations that can accept deliver of the parcel.

11. The non-transitory computer-readable medium of claim 10, wherein the one or more parcel attributes are selected from a group consisting of:
a size of the parcel;
a weight of the parcel; and
one or more special handling instructions for the parcel.

12. The non-transitory computer-readable medium of claim 11, wherein the one or more parcel attributes comprise one or more special handling instructions for the parcel selected from a group consisting of:
one or more special handling instructions related to a perishable nature of one or more contents of the parcel;
one or more special handling instructions related to one or more hazardous materials contained within the particular parcel; and
one or more special handling instructions related to one or more age-restricted items contained within the parcel.

13. The non-transitory computer-readable medium of claim 12, wherein the one or more alternate delivery location attributes comprise one or more special handling capabilities associated with the one or more alternate delivery locations.

14. The non-transitory computer-readable medium of claim 12, wherein the one or more alternate delivery location attributes comprise one or more parcel size restrictions.

15. The non-transitory computer-readable medium of claim 12, wherein the one or more alternate delivery location attributes comprise one or more parcel content restrictions.

16. A computer-implemented method of determining eligibility of a particular parcel to be redirected from a primary delivery location to an alternate delivery location comprising:
receiving, by a processor, an indication that delivery of the particular parcel is not possible at the primary delivery location;
receiving, by a processor, one or more parcel attributes for the particular parcel;
determining, by a processor, based at least in part on the one or more parcel attributes, whether the particular parcel is eligible for redirection to an alternate delivery location;
at least partially in response to determining that the particular parcel is eligible for redirection, determining a suitable alternate delivery location; and
at least partially in response to determining the suitable alternate delivery location, facilitating redirection of the particular parcel from the primary delivery location to the suitable alternate delivery location.

17. The computer-implemented method of claim 16, wherein the one or more parcel attributes comprise:
one or more dimensions of the particular parcel;
a weight of the particular parcel; and
one or more special handling instructions for the particular parcel.

18. The computer-implemented method of claim 17, wherein the one or more special handling instructions relate to a perishable nature of one or more contents of the particular parcel

19. The computer-implemented method of claim 17, wherein the one or more special handling instructions relate to one or more hazardous materials contained within the particular parcel.

20. The computer-implemented method of claim 17, wherein:
the method further comprises notifying, by a processor, an intended recipient of the particular parcel that delivery at the primary delivery location was not possible; and
determining the suitable alternate delivery location comprises enabling the intended recipient to select the suitable alternate delivery location.
